(19) United States
(12) Patent Application Publication
(10) Pub. No.: US 2004/0141574 A1
(43) Pub. Date: Jul. 22, 2004

(54) Determination of the code phase between a code modulated signal and a replica code sequence

(75) Inventor: David Akopian, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/693,260

(22) Filed: Oct. 24, 2003

(30) Foreign Application Priority Data
Oct. 24, 2002 (WO) PCT/IB02/04421

(51) Int. Cl. H04L 7/00; H04L 25/00

(52) U.S. Cl. 375/371

(57) ABSTRACT

A method for determining the code phase between a code modulated signal 21 received at a receiver and an available replica code sequence which reduces the complexity of time to frequency transform based correlations performs a multiplication (25) between a first vector (23) and a second vector (24) resulting in a third vector (26), which first vector (23) is generated based on the received signal (21) and which second vector (24) is generated based on the replica code sequence, both in an operation including a time to frequency transform. The method further comprises dividing the resulting vector (26) into sections (29) and summing (30) the samples in each section (29) to form a vector (31), upon which a frequency to time transform is performed. The invention relates equally to a corresponding receiver, to an electronic device comprising such a receiver, to a device cooperating with such a receiver and to a corresponding system.

### CROSS REFERENCE TO RELATED APPLICATIONS

This application claims priority under 35 USC §119 to International Patent Application No. PCT/IB02/04421 filed on Oct. 24, 2002.

### FIELD OF THE INVENTION

The invention relates to a method for determining the code phase between a code modulated signal received at a receiver and an available replica code sequence. The invention relates equally to a receiver, to an electronic device and a communication system comprising a receiver and to a device communicating with a receiver.

### BACKGROUND OF THE INVENTION

The code phase between a code modulated signal received at a receiver and an available replica code sequence has to be determined for example for CDMA (Code Division Multiple Access) spread spectrum receivers.

For a spread spectrum communication in its basic form, a data sequence is used by a transmitting unit to modulate a sinusoidal carrier and then the bandwidth of the resulting signal is spread to a much larger value. For spreading the bandwidth, the single-frequency carrier can be multiplied for example by a high-rate binary pseudo-random noise (PRN) code sequence comprising values of −1 and 1, which code sequence is known to a receiver. Thus, the signal that is transmitted includes a data component, a PRN component, and a sinusoidal carrier component. A PRN code period comprises typically 1023 chips, the term chips being used to designate the bits of the code conveyed by the transmitted signal, as opposed to the bits of the data sequence.

A well known system which is based on the evaluation of such code modulated signals is GPS (Global Positioning System). In GPS, code modulated signals are transmitted by several satellites that orbit the earth and received by GPS receivers of which the current position is to be determined. Each of the satellites transmits two microwave carrier signals. One of these carrier signals L1 is employed for carrying a navigation message and code signals of a standard positioning service (SPS). The L1 carrier signal is modulated by each satellite with a different C/A (Coarse Acquisition) Code known at the receivers. Thus, different channels are obtained for the transmission by the different satellites. The C/A code, which is spreading the spectrum over a 1 MHz bandwidth, is repeated every 1023 chips, the epoch of the code being 1 ms. The carrier frequency of the L1 signal is further modulated with the navigation information at a bit rate of 50 bit/s. The navigation information, which constitutes a data sequence, can be evaluated for example for determining the position of the respective receiver.

A receiver has to have access to a synchronized replica of the modulation code which was employed for a received code modulated signal, in order to be able to de-spread the data sequence of the signal. To this end, a synchronization has to be performed between the received code modulated signal and an available replica code sequence. Usually, an initial synchronization called acquisition is followed by a fine synchronization called tracking. In both synchronization scenarios, a correlator is used to find the best match between the replica code sequence and the received signal and thus to find their relative shift called code phase. The search can be performed with different assumptions on an additional frequency modulation of the received signal. Such an additional modulation may occur for example due to a Doppler effect and/or a receiver clock inaccuracy and can be as large as +/−6 kHz.

Two main types of correlators have been suggested so far. A first type of correlators performs a direct correlation of the replica code sequence and the received signal in the time domain. This implies that a dedicated processing step is carried out for each possible code phase. In case there is a large number of code phases to check, the computational burden is significant, especially for software based receivers. There exist different implementation approaches for the first type of correlators, which may be formed with matched filters or ordinary correlators. A second type of correlator relies on frequency domain acquisition techniques employing e.g. Discrete Fourier Transforms (DFT), which enable a parallel processing for all possible code phases and thus a reduction of the computational burden.

FIG. 1 illustrates a known DFT based circular correlation in the frequency domain. To simplify the illustration, the modulation code is supposed to comprise eight samples. In practice, the code will usually comprise a larger number of samples, e.g. 1024 samples. First, a vector 11 with eight samples of a received code modulated signal is provided to the correlator. Each sample in FIG. 1 is indicated by a small circle. The correlator performs a DFT 12 of the provided vector 11, resulting in another vector 13 with eight samples. Further, the correlator retrieves or calculates a conjugate 14 of the DFT of a vector comprising eight samples of an available replica code sequence. The DFT vector 13 of the received signal and the conjugate 14 of the DFT vector of the replica code sequence are then multiplied pointwise 15. For the resulting vector 16 of again eight samples, an Inverse Discrete Fourier Transform (IDFT) 17 is performed, which results again in a vector 18 comprising eight samples. Each sample of the output IDFT vector 18 corresponds to a correlation value for another one of all possible circular shifts. The vector may comprise for example the sample values [0.5 7.8 2.3 5.3 2.9 3.4 4.5 0.7] which are associated in this order to the code phases [0 1 2 3 4 5 6 7]. In the presented example, the maximal value of the output samples is 7.8, thus the found code phase is 1. This means that the replica code is shifted by one sample relative to the received code of the code modulated signal.

In principle, the phase of the received code relative to the available replica code sequence can have any possible value. In some situations, however, the range of the possible code phases can be reduced based on some apriori knowledge regarding e.g. the position of the transmitting unit, the position of the receiver and the time of transmission of the received signal. Such apriori knowledge may be available for example at assisted GPS receivers (A-GPS). Assisted GPS receivers use additional information, provided e.g. by a cellular network, to accelerate and simplify the algorithms used for position calculations.

When the location of a receiver is already known with a certain accuracy in addition to available ephemeris and time information, the synchronization procedures for acquisition and tracking would advantageously not check all possible values of the code phases but only a limited number. The conventional search in GPS is carried out for 1024 chips, which corresponds to an uncertainty area of around 300 km. Certain scenarios on the newly designed Galileo system, the European analog of GPS, could even have a search uncertainty area of a few thousands of kilometers. In an urban area, though, the position of the receiver might be known with an accuracy of about 1 km, e.g. from some assistance. This knowledge may be exploited for performing only a limited search.

There are several situations in which the range of possible code phases can be limited. For example, if a specific GPS satellite is acquired and tracked and the position of the GPS receiver is known with an accuracy of about 50 km, then the phase uncertainty is limited to ⅙^{th} of the whole range of 1023 possible code phases, as the GPS time can be reconstructed with a good accuracy. Further, if a GPS satellite was tracked and the position of the receiver determined, and then the signal is lost again, the GPS time will still continue to be quite accurate, since the internal clock was recently initialized accurately. In an urban area, it can further be assumed that the speed of the receiver is limited to 50 km/h, i.e. to about 20 m/s. Thus, the receiver can be assumed to be in a 20 km area from the previously determined position for around 20 min, and the phase uncertainty is limited 1/10^{th} of the whole range of 1023 code phases. In the latter case, the receiver might even know without assistance that only a limited number of code phases is possible.

Currently, however, a limited search of code phases can only be realized with correlators performing a correlation in the time domain. Known DFT based methods inherently perform the search of all possible code phase in parallel. Therefore, their usage is not feasible in situations in which the search is to be carried out only over a limited number of all possible code phases. With conventional DFT correlators, known limitations for the code phase can only be evaluated after the IDFT. Thus, it is a disadvantage of conventional DFT correlators that they perform in many situations unnecessary computations. Depending on the extent to which the range of the possible code phases can be limited, the use of correlators operating in the time domain might even be more reasonable again.

### SUMMARY OF THE INVENTION

It is an object of the invention to reduce the amount of required processing in a time to frequency transform based correlation procedure, which is employed for determining the code phase between a received code modulated signal and an available replica code sequence. It is in particular an object of the invention to reduce the amount of required processing for the case that the number of possible code phases can be restricted beforehand.

A method is proposed which comprises as a first step performing a multiplication between samples of a first vector and samples of a second vector resulting in a third vector. This multiplication can be realized for instance as elementwise or pointwise multiplication. The first vector is generated based on the received code modulated signal in an operation including a time to frequency transform, and the second vector is generated based on the replica code sequence in an operation including a time to frequency transform. It is to be noted that the actual generation of the second vector does not necessarily constitute a part of the proposed method. It can be stored for example for each available replica code sequence. Then, the obtained third vector is divided into sections, and the samples in each section are summed. Out of the summed samples, a reduced fourth vector is formed. Finally, a frequency to time transform of said fourth vector is performed. The frequency to time transform results in a fifth vector. Each sample of this fifth vector represents a correlation value for a different code phase between the received code modulated signal and the available replica code sequence.

Moreover, a receiver, an electronic device comprising a receiver and some other device are proposed, either comprising means for carrying out the steps of the proposed method. In case the processing is performed in another unit than the receiver, the required information about the received signals is forwarded by the receiver to this unit. The proposed other device can be for instance a network element of a network. The object is also reached with a system comprising a receiver and a device, in which system either the receiver or the device comprises means for carrying out the steps of the proposed method. In case the receiver performs the processing, the device may provide assistance data to the receiver.

The invention proceeds from the idea that the calculations performed for those code phases that do not lie within a limited range of possible code phases do not have to be skipped only in the frequency to time transform itself. Instead, the vector for which the frequency to time transform is determined can advantageously be reduced beforehand.

A time to frequency transform has the useful property that a circular shift in the input vector results in a complex sinusoidal modulation of the transform outputs which are obtained in case there is no shift. Thus, the transform outputs are the same for all possible shifts, except that they are modulated differently. The modulation frequency depends on the shifting distance, i.e. the larger the shifting, the higher the modulation frequency. In case, for example, the outputs of a time to frequency transform of a received signal are multiplied with the output of a time to frequency transform of an inverted conjugate of the replica code sequence, components of the correlation in the frequency domain modulated according to the shift are obtained. The subsequent frequency to time transform detects this modulation and outputs the largest value at a vector index corresponding to the shift value. If now the range of the possible code phases is restricted to a known value, this means that the modulation in the frequency domain is also restricted. Thus, it is possible to integrate correlation components already in the frequency domain without a preceding demodulation by a frequency to time transform. As a result, only values for those code phases which are closest to the alignment are output. The correct code phase is the output index which has the largest output value. The integration length should depend on the range of possible code phases and defines the modulation frequency range in the frequency domain.

The invention thus modifies the known time to frequency transform based correlation method to allow a parallel search over a restricted range of possible code phases. With the proposed modification, the size and complexity of the frequency to time transform can be reduced in certain scenarios, which enables an optimization of the frequency domain computations.

Compared with conventional time to frequency transform based methods, the complexity may be reduced in some situations up to tens or even hundreds of times. In case of 1023 possible code phases, for instance, the conventional time to frequency transform based frequency domain technique searches over all 1023 possibilities, while the invention is suited to optimize the frequency domain processing by reducing the search to e.g. 16 or 32 code phases.

The main complexity of a time to frequency transform based correlator is distributed equally between the forward and inverse transforms, and if the frequency to time transform size reduces dramatically, then the entire complexity will be reduced down to half. Moreover, in certain time to frequency transform based correlation methods it is possible to calculate the forward time to frequency transform only one time and to use the result with different replicas for different satellites and for different frequency bands by circularly shifting the replica. Such a method was proposed in D. Akopian, I. Kontola, H. Valio, S. Turunen, “Method in a receiver and a receiver,” patent application, Nokia Mobile Phones, 1999, and by D. Akopian in “A fast satellite acquisition method”, ION-GPS2001 Conference, Salt Lake City, USA, Sep. 11-14, 2001. In this case, the main complexity of the time to frequency transform based correlator over many frequency and satellite searches is concentrated on the frequency to time transform stage. Therefore, reducing the frequency to time transform size dramatically, i.e. by orders of magnitude, will reduce the overall cost of the correlation stage by the same amount.

The computational complexity reduction can be utilized by using a slower processor, resulting in a reduced power consumption or enabling a software-only implementation. On the other hand, with the same computational power it will be possible to perform algorithms with low complexity faster and thus to reduce delays.

Preferred embodiments of the invention become apparent from the dependent claims.

The number of sections, into which the vector resulting in the multiplication is divided, is preferably selected based on an available information on a limited range of possible code phases. The number of sections should be equal to or larger than the number of possible code phases in this limited range. The limited range of possible code phases can be determined in particular based on available information on a position of the receiver.

Advantageously, but not necessarily, the sections are of equal size. If they are not of equal size, the outputs will be distorted, but the frequency to time transform can be modified to account for this inequality.

In order to cope with a multipath propagation of the code modulated signal, the code modulated signal may be correlated in accordance with the invention with a plurality of identical replica code sequences which are shifted in phase. To this end, a plurality of similar correlators may be provided.

The first and the second vector multiplied in the multiplication can be obtained in various ways.

The first vector can be obtained for example by performing a time to frequency transform of the received code modulated signal. In this case, the second vector can be given e.g. by a vector resulting in a time to frequency transform of the inverted conjugate of the replica code sequence. Alternatively, the second vector can be given in this case by the conjugate of a vector resulting in a time to frequency transform of the replica code sequence.

On the other hand, the second vector can be obtained by performing a time to frequency transform of the replica code sequence. In this case, the first vector can be given e.g. by a vector resulting in a time to frequency transform of the inverted conjugate of the received code modulated signal. Alternatively, the first vector can be given in this case by the conjugate of a vector resulting in a time to frequency transform of the received code modulated signal.

The time to frequency transform performed for obtaining the first and second vector can be in particular, though not exclusively, a DFT. Correspondingly, the frequency to time transform performed for obtaining the fifth vector can be in particular, though not exclusively, an IDFT.

The time to frequency transform can be implemented as a fast computational method, for example a Fast Fourier Transform or any other suitable approach.

The invention can be used in both acquisition and tracking schemes. In tracking, e.g. multiple shifted correlators could be utilized for multipath mitigation.

The invention may be used in both cases for determining the code phase and the frequency of a remaining complex sinusoidal modulation, i.e. of the sinusoidal modulation which remains after the carrier has been wiped off from the received signal based on the known nominal carrier frequency. The code phase is determined according to the peaks of a cross-correlation function, and the correlation is calculated at initial code wipe-off stages. The processing for weak signals requires additional coherent and non-coherent integrations. The invention can therefore also be used as a building block for other methods implementing different scenarios of coherent and/or non-coherent processing for possible multiple frequency candidates.

The invention can be implemented in hardware or in software. In case the invention is employed as part of acquisition and tracking algorithms, the implementation corresponds advantageously to the implementation of these algorithms.

The invention can be employed in particular, though not exclusively, for CDMA spread spectrum receivers, for instance for a receiver of a positioning system like GPS or Galileo.

### BRIEF DESCRIPTION OF THE FIGURES

Other objects and features of the present invention will become apparent from the following detailed description considered in conjunction with the accompanying drawings, wherein

FIG. 1 illustrates a DFT based correlation according to the state of the art; and

FIG. 2 illustrates a DFT based correlation according to an embodiment of the invention.

### DETAILED DESCRIPTION OF THE INVENTION

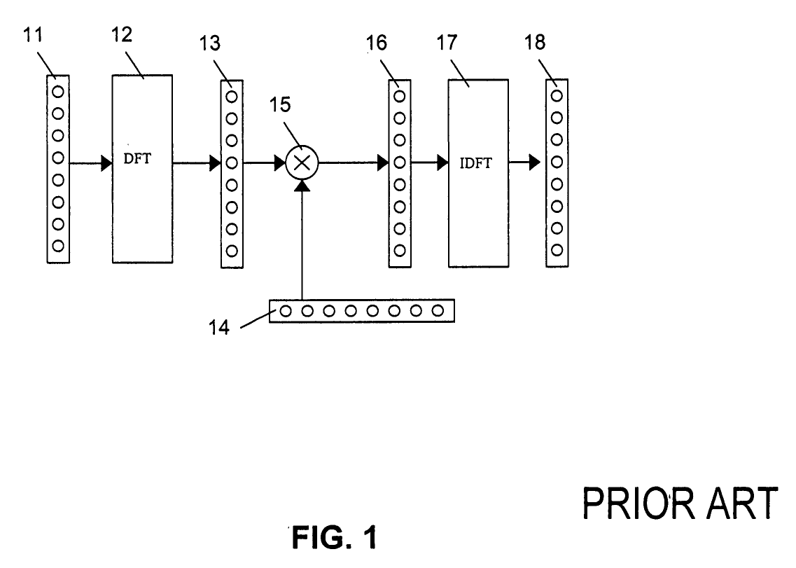

FIG. 1 has already been described above.

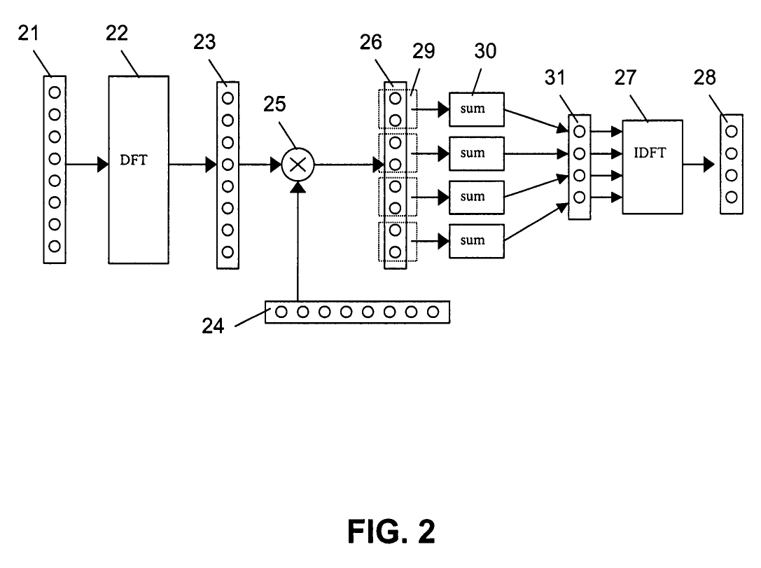

FIG. 2 illustrates an exemplary embodiment of the method according to the invention implemented in an A-GPS receiver. The receiver comprises a receiving unit for receiving signals from different GPS satellites which are modulated with different C/A-codes, each comprising 1023 chips per code period. Moreover, the GPS receiver comprises a tracking unit with a correlator employing DFT based frequency domain acquisition techniques for acquiring and tracking received satellite signals. The tracking unit has access to a replica code sequence for each of the GPS satellites. The GPS receiver is furthermore included in a mobile terminal of a communication system. A microcontroller unit (MCU) of the GPS receiver is able to store and evaluate assistance information received by this mobile terminal from a communication network or information available at the receiver.

It will be assumed in the following that the number of samples N per code period of received satellite signals is equal to a power of two, i.e. in the current example 1024 chips instead of 1023 chips. Other cases can be explored in a similar manner.

In a first step, a C/A code modulated input signal x={x₀, . . . , x_{N-1}} received at the receiver is provided to the correlator. In FIG. 2, the input signal x is represented for reasons of simplicity by a vector 21 comprising eight samples instead of 1024 samples. As in FIG. 1, each sample is indicated by a small circle in FIG. 2.

In the correlator, a DFT 22 of the input signal x={x₀, . . . , x_{N-1}} is performed. In case the DFT matrix is denoted as F, the resulting vector y¹ is given by

y¹=F_{N}x.

Vector y¹ is represented in FIG. 2 by another vector 23 comprising eight samples.

Further, a vector r resulting in a DFT of the inverted conjugate of the replica code sequence is provided. In FIG. 2, this vector r is represented by yet another vector 24 comprising eight samples.

In a next step 25, vector y¹ is multiplied pointwise with vector r. The resulting vector y² is given by

y²=y¹.*r

The pointwise operation is denoted as “.*”. Also vector y² is represented in FIG. 2 by a vector 26 comprising eight samples.

So far, the processing by the correlator corresponds to the known DFT based processing described with reference to FIG. 1.

In contrast to the known processing, however, the vector y² resulting in the pointwise multiplication 24 is not subjected immediately to an IDFT 27. Rather, it is first divided into K sections 29 of equal size. The value of K is set by the MCU to the number of possible code phases, which number is determined by the MCU based on available assistance data.

In the example of FIG. 2, eight different code phases [0 1 2 3 4 5 6 7] may exists in the whole. Due to available assistance data on a reference position of the receiver and of the satellite transmitting the received signal, it is known that currently at the most a code shift by 1 in one direction and by 2 in the opposite direction may occur.

This corresponds e.g. to the four possible code phases [0 1 6 7], since the code phases are circular. “0” corresponds to an exactly aligned input signal and replica code sequence, “1” corresponds to an alignment shifted by one sample in one direction, “7” corresponds to an alignment shifted by one sample in the opposite direction, and “6” corresponds to an alignment shifted by two samples in the opposite direction. The limitation to four code phases results in a value of K=4. Thus, in FIG. 2 the eight samples are divided into four sections 29 of two samples each. In GPS, this would corresponds to 512 sections of two samples each.

The samples in each section are then summed 30. The result is a vector y³ of a reduced size K. Vector y³ is represented in FIG. 2 by a vector 31 comprising four samples.

The IDFT 27 is now applied to this reduced vector 31 according to the following equation:

z=F⁻¹_{K}y³

Vector z is represented in FIG. 2 by a vector 28 comprising again four samples.

The interpretation of the output index of the IDFT 27 and thus of the expected correlation peak index is as follows. The IDFT algorithm finds the code phases around the aligned position corresponding to a code phase of “0”. The possible values are {−K/2, . . . , −1,0,1, . . . ,K/2−1}. The values of the first K/2 samples of vector z correspond to positive shifts {0,1, . . . ,K/2−1} while the values of the next K/2 samples of vector z correspond to negative shifts {−K2, −1}. In the above example, the outputs of the IDFT are thus associated to the phases [0 1 6 7]. Proceeding from the exemplary correlation values presented with reference to FIG. 1, the output vector 28 in FIG. 2 would be [0.5 7.8 4.5 0.7]. The final result is the same as in FIG. 1, i.e. the sample with the maximum value is the second one, and thus the code phase is 1. This time, however, the output samples which are not needed due to an apriori knowledge of limitations for the possible code phases are not calculated at all.

The vector z resulting in the IDFT 27 can further be used for an additional coherent and/or non-coherent processing which is performed for handling low strength signals in noise.

Also in cases in which the correlation should be performed for different values of a remaining complex sinusoidal modulation after the carrier wipe-off, there is no need to perform a DFT transform for each possible modulation frequency. Instead, a shift of the transformed replica code sequence could be used. In this case, a reduction in complexity of the IDFT 27 according to the invention has a particular benefit. For example, when the A-GPS receiver position is known with an accuracy of 3000 m, this corresponds to a search area of approximately 10 code phases. For simplicity, the closest power of two, 16, is taken for the number of candidate code phases to search. The complexity reduction will then be approximately (1024*10)/(16*4)=160 times over the conventional DFT based correlator.

It is to be noted that the described embodiment constitutes only one of a variety of possible embodiments of the invention.

1. A method for determining the code phase between a code modulated signal (21) received at a receiver and an available replica code sequence, said method comprising:
performing a multiplication (25) between samples of a first vector (23) and samples of a second vector (24) resulting in a third vector (26), which first vector (23) is generated based on said received code modulated signal (21) in an operation including a time to frequency transform (22) and which second vector (24) is generated based on said replica code sequence in an operation including a time to frequency transform;
dividing said third vector (26) into sections (29) and summing (30) the samples in each section (29);
forming a reduced fourth vector (31) out of the summed samples; and
performing a frequency to time transform (27) of said fourth vector (31) resulting in a fifth vector (28), each sample of said fifth vector (28) representing a correlation value for a different code phase.

2. A method according to claim 1, wherein said multiplication (25) between samples of said first vector (23) and samples of said second vector (24) is realized as pointwise multiplication.

3. A method according to claim 1, wherein said multiplication between samples of said first vector and samples of said second vector is realized as elementwise multiplication.

4. A method according to claim 1, wherein the number of said sections (29) is selected based on an available information on a range of code phases which are possible in a current situation.

5. A method according to claim 4, wherein the number of said sections (29) is selected to be equal to or larger than the number of code phases in said range.

6. A method according to claim 4, wherein said range of code phases is determined based on available information on a position of said receiver.

7. A method according to claim 1, wherein said sections (29) are of equal size.

8. A method according to claim 1, wherein said code modulated signal is correlated with a plurality of identical replica code sequences which are shifted in phase.

9. A method according to claim 1, further comprising a subsequent coherent and/or noncoherent processing for handling signals of low strength.

10. A method according to claim 1, wherein said first vector (23) is obtained by performing a time to frequency transform (22) of said received code modulated signal (21), and wherein said second vector (24) is given by a vector resulting in a time to frequency transform of the inverted conjugate of said replica code sequence.

11. A method according to claim 1, wherein said first vector is obtained by performing a time to frequency transform of said received code modulated signal, and wherein said second vector is given by the conjugate of a vector resulting in a time to frequency transform of said replica code sequence.

12. A method according to claim 1, wherein said first vector is given by a vector resulting in a time to frequency transform of the inverted conjugate of said received code modulated signal, and wherein said second vector is obtained by performing a time to frequency transform of said replica code sequence.

13. A method according to claim 1, wherein said first vector is given by the conjugate of a vector resulting in a time to frequency transform of said received code modulated signal, and wherein said second vector is obtained by performing a time to frequency transform of said replica code sequence.

14. A method according to claim 1, wherein said time to frequency transforms are realized as Discrete Fourier Transforms.

15. A method according to claim 1, wherein said time to frequency transforms are realized as Fast Fourier Transforms.

16. A method according to claim 1, wherein said frequency to time transform is realized as Inverse Discrete Fourier Transform.

17. A method according to claim 1, wherein said code modulation of said received code modulated signal is a Code Division Multiple Access (CDMA) spread spectrum modulation.

18. A use of a method according to claim 1 in a process for acquisition and/or tracking of code modulated signals received at a receiver.

19. A receiver comprising
receiving means for receiving code modulated signals; and
processing means for carrying out the method according to claim 1.

20. A receiver according to claim 19, which receiver is a receiver of a positioning system.

21. An electronic device comprising a receiver according to claim 19.

22. An electronic device according to claim 21, wherein said electronic device is a mobile terminal capable of communicating with a communication network.

23. A device comprising
means for receiving from a receiver information on code modulated signals received by said receiver; and
processing means for carrying out the method according to claim 1.

24. A device according to claim 23, which device is a network element of a network.

25. A system comprising
a receiver comprising means for receiving code modulated signals, and means for providing information on received code modulated signals; and
a device according to claim 23.

26. A system comprising
a receiver according to claim 19; and
a device for providing assistance data to said receiver.

27. A system according to claim 26, wherein said device is a network element of a network.

28. A system according to claim 25, wherein said system is a positioning system.
